(19) United States
(12) Patent Application Publication
(10) Pub. No.: US 2006/0000321 A1
(43) Pub. Date: Jan. 5, 2006

(54) Hand tool structure

(76) Inventor: Hung-Ming Hu, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/879,070

(22) Filed: Jun. 30, 2004

(51) Int. Cl. B25B 15/00

(52) U.S. Cl. 81/489

(57) ABSTRACT

A hand tool structure includes a handle and a screw head rod. The handle is formed by pouring liquid plastic material into a cave of a mold. The screw head rod comprises a screw head at one end and a plurality of ribs at an opposite end. An end block is formed at the endmost of the ribs. When liquid plastic material is poured into the cave of the mold, the end block will slow down the pouring speed to eliminate any bubbles formed within the cave of the mold. The end block enlarges the contacting area between the screw head rod and the plastic material to enhance the striking force of the hand tool.

### BACKGROUND OF THE INVENTION

1. Field of the Invention

This invention relates to a hand tool structure, and more particularly to a structure that eliminates bubbles from producing in the handle during injection to increase the strength of the hand tool.

2. Description of the Prior Art

A conventional hand tool, as shown in FIG. 4, includes a handle A and a screw head rod B. The screw head rod B has one end formed into a screwdriver or a socket B1, while the other end is formed with a plurality of ribs B2. The ribs B2 are seated in the cave C1 of a mold C, so that when liquid plastic material is poured through an injecting gate C2 of the mold C, the screw head rod B2 is integral with the handle A.

This prior art has a number of shortcomings:
1. The connection between the handle A and the screw head rod B relies on the ribs B2. This connection is too weak. It is sometimes easy to be broken or loosened.
2. When pouring liquid plastic material into the mold, it sometimes produces bubbles within the handle A. This weakens the strength of the handle as well.

### SUMMARY OF THE INVENTION

It is the primary objective of the present invention to provide a hand tool structure, which eliminates bubbles from producing in the handle during the molding procedure. Thus, it is more solid and stronger.

It is another objective of the present invention to provide a hand tool structure, which utilizes an end block to increase contacting area between the screw head rod and the plastic material to enhance the hand tool lifetime.

It is a further objective of the present invention to provide a hand tool structure, which is safe and easy to use.

### BRIEF DESCRIPTION OF THE DRAWINGS

FIG. 1 is an exploded view of the present invention;

FIG. 2 is a view of a mold of the present invention, showing an injecting gate for liquid plastic material to be poured into the mold;

FIG. 3 is a cross-sectional view of the present invention; and

FIG. 4 is a view of a mold of a prior art.

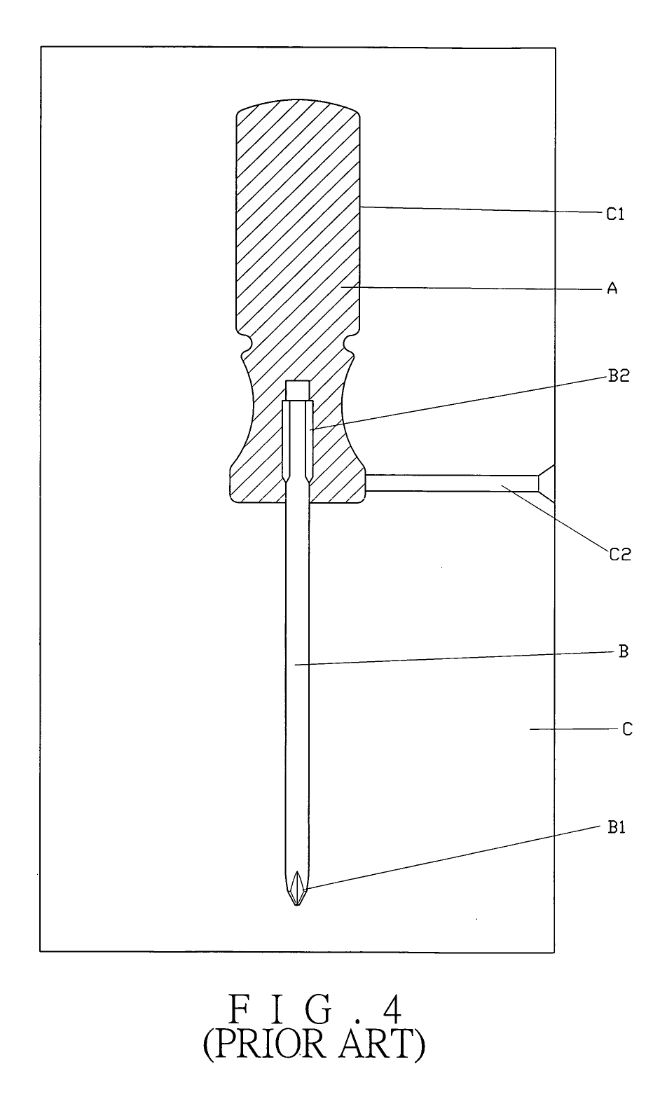

### DETAILED DESCRIPTION OF THE PREFERRED EMBODIMENT

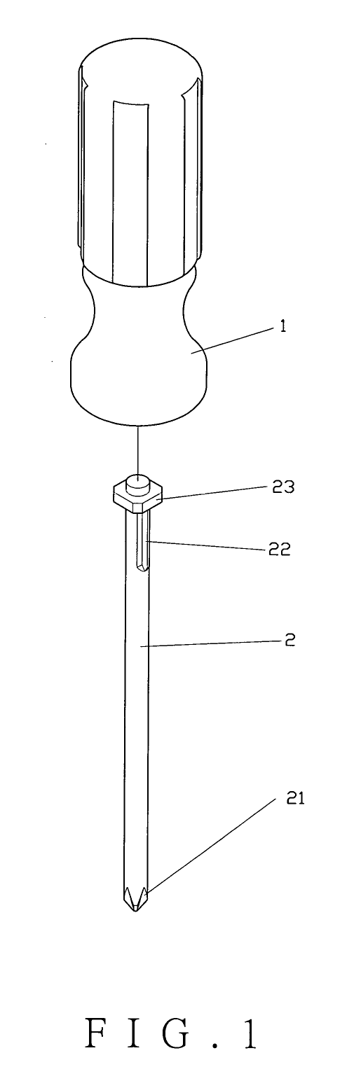

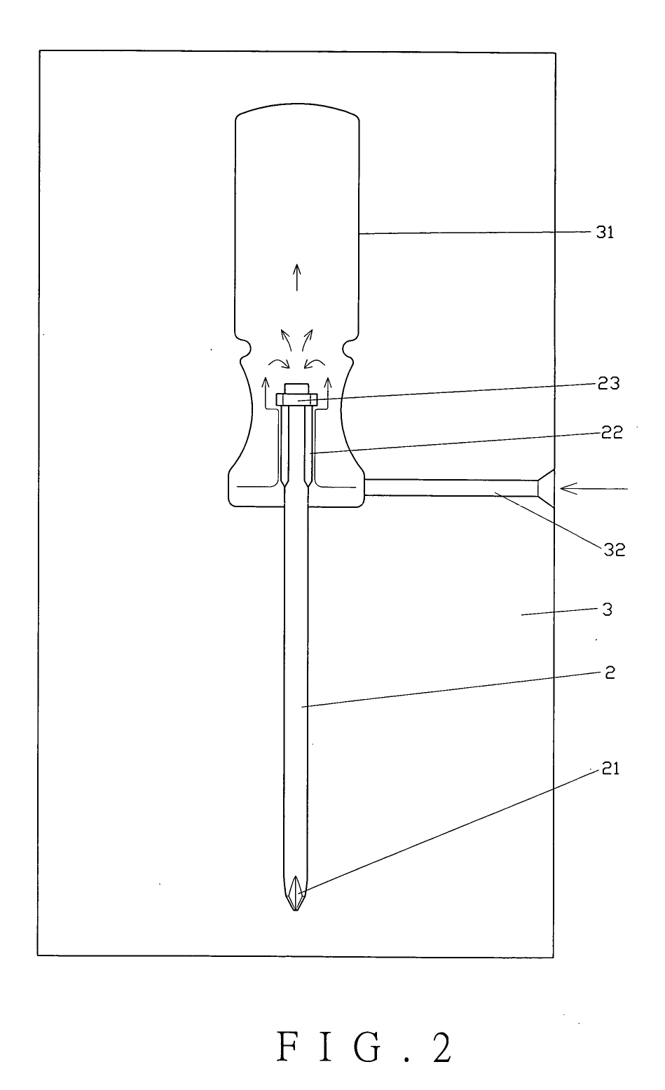

As shown in FIGS. 1 and 2, the present invention comprises a handle 1 and a screw head rod 2.

The handle 1 is formed by pouring liquid plastic material into a cave 31 of a mold 3. The screw head rod 2 has a screw head 21 at one end and a plurality of ribs 22 at the other end. An end block 23 is formed at the endmost of the ribs 22. The end block 23 may be a separated one secured to the screw head rod 2.

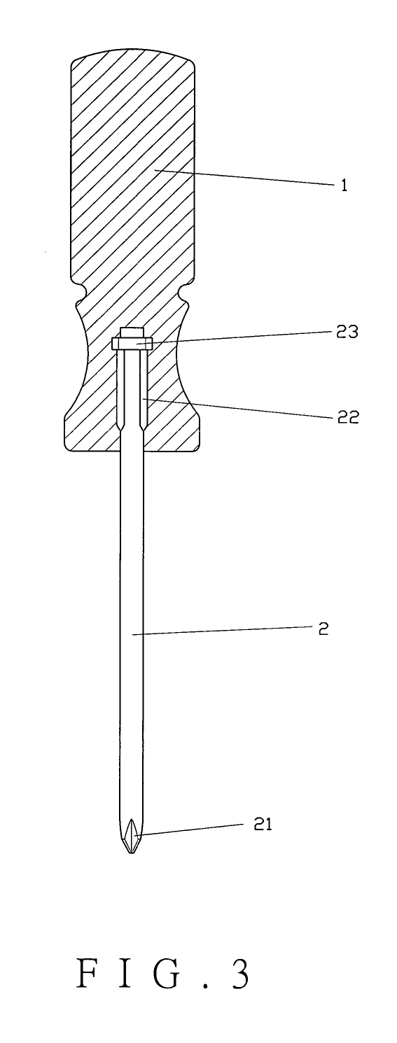

To manufacture the present invention, as shown in FIGS. 2 and 3, place the end block 23 with the ribs 22 of the screw head rod 2 into the cave 31 of the mold 3 and pour liquid plastic material into the cave 31 through an injecting gate 32. The liquid plastic material poured into the cave 31 of the mold 3 will flow through the end block 23, which forms turbulence in the cave 31. This slows down the pouring speed and eliminates bubbles from forming in the handle 1. Due to the end block 23, the contacting area between the screw head rod 2 and the plastic material are enlarged, which enhances the sustainability of striking force towards to the hand tool, and the ribs 22 around the screw head rod 2 also enhances the torque force of the hand tool as well. Thus, the strength of the handle 1 is improved more than double with respect to the handles of conventional screwdrivers.

Further, the screw head rod 2 may be formed with a threaded section to secure a nut at the endmost to slow down the pouring speed and cause turbulence within the cave 31 of the mold 3.

I claim:

1. A hand tool structure comprising a handle and a screw head rod, wherein said handle is formed by pouring liquid plastic material into a cave of a mold, and said screw head rod comprises a screw head at one end and a plurality of ribs at an opposite end, and characterized in that:
said screw head rod comprising an end block at the endmost of said ribs.

2. The hand tool structure, as recited in claim 1, wherein said end block is a nut, and said screw head rod at the endmost of said ribs is formed with a threaded section to secure said nut thereat.
